(19) United States
(12) Patent Application Publication
(10) Pub. No.: US 2009/0144669 A1
(43) Pub. Date: Jun. 4, 2009

(54) METHOD AND ARRANGEMENT FOR ENHANCING PROCESS VARIABILITY AND LIFETIME RELIABILITY THROUGH 3D INTEGRATION

(75) Inventors: Pradip Bose, Yorktown Heights, NY (US); Eren Kursun, Ossining, NY (US); Jude A. Rivers, Cortlandt Manor, NY (US); Victor Zyuban, Yorktown Heights, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/947,207

(22) Filed: Nov. 29, 2007

(51) Int. Cl. B25B 11/00

(52) U.S. Cl. 716/1

(57) ABSTRACT

A method of enhancing semiconductor chip process variability and lifetime reliability through a three-dimensional (3D) integration applied to electronic packaging. Also provided is an arrangement for implementing the inventive method.

### BACKGROUND OF THE INVENTION

1. Field of the Invention

The present invention relates to a method for enhancing semiconductor chip process variability and lifetime reliability through three-dimensional (3D) integration. Also provided is an arrangement for implementing the inventive method.

2. Background of the Invention

Increased requirements in power density and technology scaling for electronic package components have encountered considerably increased existing reliability problems in recent years, as a result of which lifetime reliability and process variation has already been elevated to the “critical challenges” category according to ITRS 2005 in the technology.

Chip lifetime reliability has traditionally been ensured through process qualification and sorting out of defective chips through accelerated degradation techniques like process burn-in. The utilization of structural duplication is considered as another standard technique for dealing with lifetime reliability issues; however, the corresponding required overhead in terms of increased cost, manufacturing area and complexity, generally limits the extent of applicability thereof in practice. Similarly, the traditional burn-in process that is used to accelerate extrinsic failures is reaching a point where it is raising a number of complications and is becoming more difficult to implement with each successive process generation. In some instances, burn-in is believed to cause lifetime reliability problems itself, as a result of which, there has been an increased degree of interest in developing alternative techniques for improving the chip lifetime reliability without the burn-in process in recent years.

There is a significant amount of cost associated with the process variation in technologies, especially at levels of 32 nm and below. Lost yield due to process variability causes millions of dollars in wasted expenditures every year per production line. There is significant cost and problems associated with lost yield due to process variation in current and next generation technologies. These include timing and associated functionality problems, performance reduction due to the timing changes, increase in chip footprint due to the additional blocks, ability to handle only single fault and single type of fault due to lack of intelligence in the current approaches to dealing with variability.

In order to provide clear advantages over the current state of the technology, in accordance with the invention, there is proposed a technique that is adapted to alleviate lifetime reliability and process variability issues through the intermediary of three-dimensional (3D) integration. Even though the motivation for 3D integration has been largely interconnect-driven and packaging-oriented, 3D integration can provide further broader advantages when effectively utilized.

### SUMMARY OF THE INVENTION

In order to implement the foregoing, there is provided a method for enhancing the lifetime reliability and process variability through effective use of three-dimensional integration technology. An auxiliary so-called healing layer is attached to an original processor die through 3D integration. This one-fits-all auxiliary layer can solve any reliability or variability problem automatically at run time, and preserves the synchronous timing while potentially improving the performance of a faulty chip compared to the baseline. Pursuant to a further aspect as described in copending application Ser. No. ______ (Docket No. YOR920070446US1). More extensively, proposed is an intelligent on-chip controller which manages the redundancy in the auxiliary layer, including exact replicas of number of critical blocks; generic and configurable logic resources; configurable wiring and high-bandwidth low-latency interconnect to the primary layer. The invention, thus, focuses on utilizing these resources through 3D integration in order to improve upon lifetime reliability and variability.

A primary aspect of the invention resides in utilizing the available 3D redundancy, by dynamically adjusting the processor resources on both layers, i.e., primary and device layers, simultaneously including logic and interconnectivity in order to bring the system to a state at which it can achieve at least the same or improved performance over the baseline. High-end server systems are good candidates for this “healing/compensating layer technique”. Not only does the additional memory hierarchy in this layer provide performance improvement, the reconfigurable redundancy enables enhanced lifetime reliability in recovering from a wide range of faults.

### BRIEF DESCRIPTION OF THE DRAWINGS

The foregoing is clearly emphasized by referring to the accompanying drawings, wherein the inventive concept is illustrated on the parts and full integration of three-dimensional embodiments of an electronic package; wherein:

FIG. 1 shows a primary semiconductor chip and an auxiliary (or secondary) semiconductor chip for incorporation into a three-dimensional semiconductor chip. The auxiliary chip incorporates duplicated resources along with the regular logic; and

FIG. 2 illustrates, generally diagrammatically, an embodiment of superimposed semiconductor chip layers for effectuating the three-dimensional integration process; and

FIG. 3 illustrates another embodiment of the invention wherein an auxiliary semiconductor chip is placed in the middle of two primary semiconductor chips forming a 3-layer three-dimensional semiconductor chip.

### DETAILED DESCRIPTION OF THE INVENTION

Pursuant to the method for enhancing lifetime reliability and/or performance that uses 3D integration, there are employed at least two chips where the first chip is a microprocessor. The second chip consists of a set of execution/memory resources configurable as either redundant resource for the microprocessor and microcontroller for managing and reconfiguring the resources in response to detection of a need for replacing a resource in the first chip in a sequence of steps where as a first step the pool of existing execution or memory resources is scanned to find an eligible replacement for the resource marked for replacement. If the eligible resource is not available, one of the reconfigurable resources is configured to replace the resource that is marked for replacement. Hereby, one or more of the execution/memory resources in the second chip is configured to work as a performance enhancer for one of the resources in the first chip (such as a second pipeline in the auxiliary device layer).

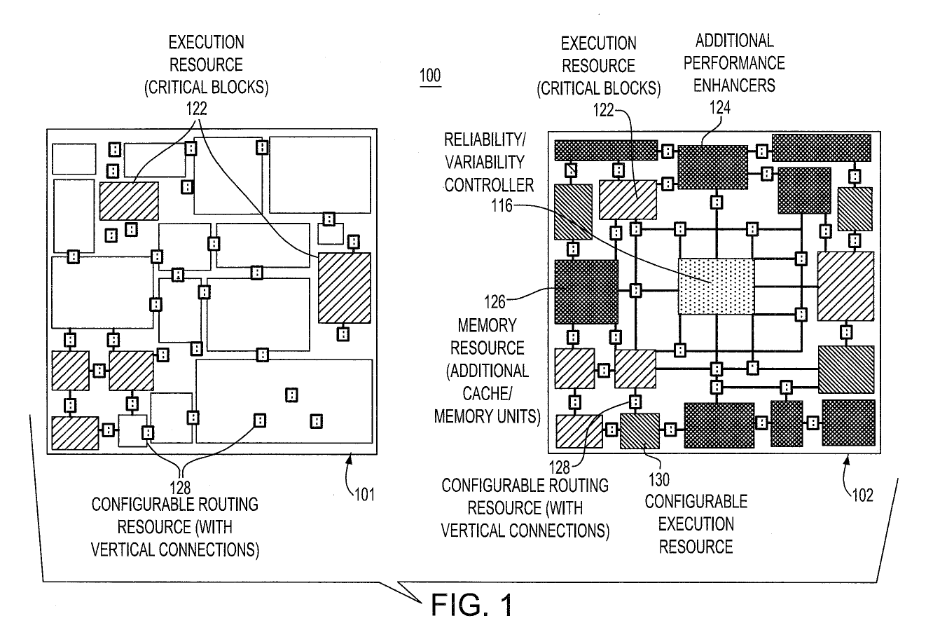

Referring in detail to FIG. 1 of the drawings, a diagrammatic implementation 100 of the basic components of this invention is presented: a floor plan of a primary semiconductor chip 101 and an auxiliary (or secondary) semiconductor chip 102.

The primary chip or layer 101 may be a regular two-dimensional semiconductor microprocessor chip, with additional and necessary resources for 3D chip integration. The resources in the first chip may be complete processor cores, functional units, control macros, elements of the processor dataflow, register files, memory arrays, whereby there is also provided in the auxiliary (or secondary) chip, redundancy for critical macros, such as vector, fixed or floating point execution blocks, auxiliary pipelines, accelerator cores, as well as generic configurable logic such as filed programmable gate arrays and programmable logic macros, wherein the custom macros are embedded in the configurable fabric thereof. In the drawing of FIG. 1 of the primary chip 101, we only highlight on-chip blocks or structures 122, 128 which may have exact replicas on the secondary layer chip 102.

The auxiliary device layer or chip 102 includes: (i) On-chip reliability/variability controller 116: capable of monitoring on-chip resources, recovering from faults and process variability induced differences through activating/deactivating/configuring one or more of the logic or memory units or interconnect on the chip; (ii) Exact replicas of critical blocks 122 on the first/primary chip layer, whereby both layers 101, 102 have matching floor plans, where the duplicates are located vertically on top of the originals. However, not all units in a microprocessor are of equal criticality. Units such as register files, issue or fetch logic are of higher importance compared to cache memory and other prediction structures whose faults can be tolerated to a certain extent; (iii) Generic logic 130: for use as redundancy for various faults (lookup tables of configurable sizes, stacks); (iv) Configurable logic 130: for use for multiple purposes (configured by the on-chip controller); (v) Configurable interconnect 128 (lateral and vertical) and switch boxes: for connecting/disconnecting the replica or original blocks as well as using the generic or configurable logic blocks; and (vi) Additional memory elements 126 (SRAM, DRAM, eDRAM) and other structures 124 for performance improvement.

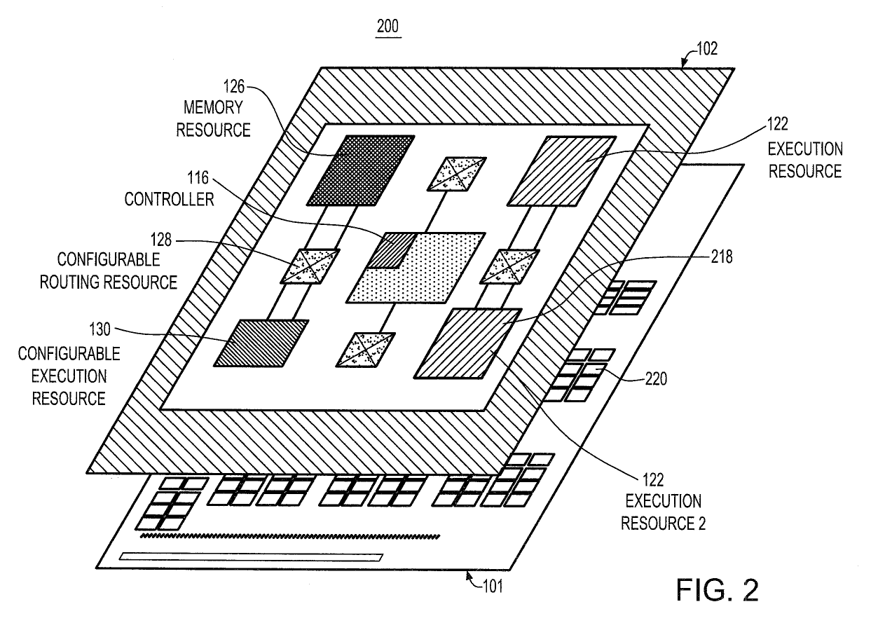

Referring now in detail to FIG. 2 of the drawings, the concept is represented on a 2-layer 3D embodiment 200, having first and second layers 101, 102. The second device layer 102 includes an on-chip variability/reliability controller 116, as well as redundant resources 218 that can be activated if a primary unit 220 in the first device layer 101 is faulty. The on-chip controller 116 activates any idle blocks while inactivating (turning off and by-passing) faulty units. Moreover, it includes performance-enhancing resources 122, 124, 126, 128, 130, additional cache/memory hierarchy such as DRAM or SRAM as well as monitoring and recovering capabilities.

The connection between the primary copy of a block and the redundancy which is placed on the top layer 102 may be achieved through vertical interconnects 128, such as TSVs (through-the-silicon-vias). The configurable interconnect 128 can be adjusted to connect either copy of the fault domains to the rest of the chip in case of a fault. This configuration is achieved through the use of switch boxes or multiplexers (not shown).

The floor plans of the primary and secondary chip layers 101, 102 match in terms of critical block placement, such that for critical blocks the replicas in the secondary chip 102 are located on top of the primary units in the primary chip 101. This approach provides significant reduction in the interconnect length and latency. As the distances between 2 device layers can be 20-50 um in the current 3D integration, the vertical delay between the original and the redundant unit is less than FO4. Hence, the synchronous timing is preserved. Also, asynchronous cases are easily handled with the same scheme.

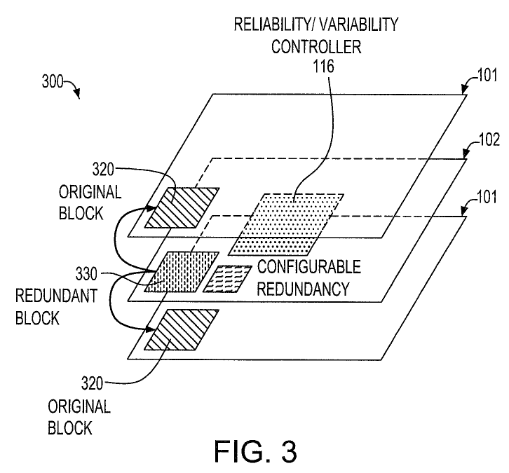

Referring now in detail to FIG. 3 of the drawings, the inventive concept is further represented on a 3-layer 3D embodiment 300, having first 101, second 102 and third 101 layers. In this embodiment, one auxiliary (or secondary) chip 102 is stacked in between two primary chips 101. The second device layer 102 includes an on-chip variability/reliability controller 116, as well as a configurable and custom redundant resource 330 that can be activated and dynamically assigned to either of the primary chips 101 if a primary unit 320 in either of the primary device layers 101 becomes faulty during system runtime. Also, if the primary units 320 in both primary chips 101 become faulty, the configurable redundant resource 330 on the secondary chip 102 can be used to replace both, albeit at a reduced system performance.

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but to fall within the spirit and scope of the appended claims.

What is claimed is:

1. A method for enhancing semiconductor chip process variability and lifetime reliability through a three-dimensional integration applied to electronic packaging, said method comprising:
(a) providing a first semiconductor chip essentially consisting of a microprocessor, a plurality of performance and memory resources, including selectively functional units, control macros, elements of data flow, register files and memory arrays;
(b) providing one or more second semiconductor chips in a superimposed arrangement over said first semiconductor chip, said second semiconductor chip including an on-chip controller and redundant resources actuatable upon recognition of a faulty resource or plurality of faulty resources on said first semiconductor chip;
(c) configuring at least one of the redundant resources on said second semiconductor chip as a performance enhancer for at least one of the resources on said first semiconductor chip; and
(d) incorporating redundancies on said second semiconductor chip thereon for critical macros on said first semiconductor chip selectively comprising vectors, fixed or floating point execution blocks, auxiliary pipelines and diverse component units.

2. An arrangement for enhancing semiconductor chip lifetime reliability through a three-dimensional integration applied to electronic packaging, said arrangement comprising:
(a) a first semiconductor chip essentially consisting of a microprocessor, a plurality of performance and memory resources, including selectively functional units, control macros, elements of data flow, register files and memory arrays;
(b) a second semiconductor chip being located in a superimposed arrangement over said first semiconductor chip, said second conductor chip including an on-chip controller and redundant resources actuatable upon recognition of a faulty resource or plurality of faulty resources on said first semiconductor chip;
(c) at least one of the redundant resources on said second semiconductor chip being configured as a performance enhancer for at least one of the resources on said first semiconductor chip; and
(d) redundancies incorporated on said second semiconductor chip for critical macros on said first semiconductor chip selectively comprising vectors, fixed or floating point execution blocks, auxiliary pipelines and diverse component units.
